(19) United States
(12) Patent Application Publication
(10) Pub. No.: US 2021/0179087 A1
(43) Pub. Date: Jun. 17, 2021

(54) PARKING ASSIST DEVICE, PARKING ASSIST METHOD, AND COMPUTER PROGRAM PRODUCT

(71) Applicant: HONDA MOTOR CO., LTD., Tokyo (JP)

(72) Inventors: Miki TSUJINO, Wako-shi (JP); Yasushi SHODA, Wako-shi (JP); Hiroshi YAMANAKA, Wako-shi (JP)

(21) Appl. No.: 17/118,726

(22) Filed: Dec. 11, 2020

(30) Foreign Application Priority Data
Dec. 13, 2019 (JP) 2019-225907

(51) Int. Cl. B60W 30/06; B62D 15/02; G08G 1/16

(52) U.S. Cl. CPC B60W 30/06; B62D 15/0285; B60W 2050/146; B60W 2554/801; G08G 1/168

(57) ABSTRACT

A parking assist device provides control over a subject vehicle of interest such that the subject vehicle parks into a target parking location, based on information obtained by recognizing surroundings of the subject vehicle. The parking assist device includes: a parking available position detection part configured to detect one or more parking available locations each of which is a location available for the subject vehicle to park, based on the recognition information; and a target parking position determination part configured to, when the parking available position detection part detects a plurality of the parking available locations, extract a prescribed number or a smaller number of candidate parking locations from among the detected parking available locations, based on a distance between a current location of the subject vehicle and each of the parking available locations, display the extracted candidate parking locations in a display device, and selects a target parking location from among the displayed candidate parking locations.

### CROSS REFERENCE TO RELATED APPLICATIONS

This application claims the benefit of Japanese Patent Application No. 2019-225907 filed on Dec. 13, 2019, the disclosure of which is incorporated herein by reference.

### BACKGROUND OF THE INVENTION

### 1. Field of the Invention

The present invention relates to a parking assist device, a parking assist method and a computer program product.

### 2. Description of the Related Art

In parking a vehicle in a parking lot, an automatic parking system has been proposed in which: a vehicle uses a camera or the like installed therein to detect a parking space in a parking lot; and an automatic parking into the detected parking space is performed.

Japanese Laid-Open Patent Application, Publication No. 2019-137397 (to be referred to as Patent Document 1 hereinafter) discloses a parking assist device in which, when there are a plurality of parking available areas in a parking lot, one of the parking available areas is selected that is safer having a smaller possibility of coming in contact with an obstacle during a parking operation or when a vehicle is parked and an occupant is getting out of the vehicle, compared to the other parking available areas.

Japanese Laid-Open Patent Application, Publication No. 2016-16681 (to be referred to as Patent Document 2 hereinafter) discloses a parking frame recognition device in which a vehicle of interest detects a parking available space (a parking frame), using images taken by an imaging part installed therein. When a plurality of parking available areas are detected, the parking frame recognition device: determines respective degrees of recommendations of the parking available areas in an easy-to-park order; and displays the detected parking available areas to each of which information showing the determined degrees of recommendations is added.

### RELATED ART DOCUMENTS

### Patent Documents

[Patent Document 1] Japanese Laid-Open Patent Application, Publication No. 2019-137397

[Patent Document 2] Japanese Laid-Open Patent Application, Publication No. 2016-16681

### SUMMARY OF THE INVENTION

In parking assist control disclosed in Patent Documents 1 and 2, when a plurality of parking available spaces are detected, all of them are displayed, which is in some cases too many and a driver (a user) feels bothersome.

In light of the problem as described above, the present invention has been made in an attempt to, when a plurality of parking available locations are detected, provide a user with information on the parking available locations in an easy-to-understand manner.

A parking assist device provides control over a subject vehicle of interest such that the subject vehicle parks into a target parking location, based on information obtained by recognizing surroundings of the subject vehicle. The parking assist device includes: a parking available position detection part configured to detect one or more parking available locations each of which is a location available for the subject vehicle to park, based on the recognition information; and a target parking position determination part configured to, when the parking available position detection part detects a plurality of the parking available locations, extract a prescribed number or a smaller number of candidate parking locations from among the detected parking available locations, based on a distance between a current location of the subject vehicle and each of the parking available locations, display the extracted candidate parking locations in a display device, and selects a target parking location from among the displayed candidate parking locations.

The present invention can provide, when a plurality of parking available locations are detected, a user with information on the parking available locations in an easy-to-understand manner.

### BRIEF DESCRIPTION OF THE DRAWINGS

FIG. 1 is a block diagram illustrating a system configuration focusing on an automatic parking control unit according to an embodiment of the present invention.

FIG. 2 is a top view illustrating at which position on a subject vehicle each of a group of cameras and a group of sonars is mounted according to the embodiment of the present invention.

FIG. 3 is a diagram illustrating a structure of a front interior section of the subject vehicle according to the embodiment of the present invention.

FIG. 4 is a top view of a parking lot for explaining how an automatic parking of the subject vehicle is performed according to the embodiment of the present invention.

FIG. 5 is another top view of the parking lot for explaining how an automatic parking of the subject vehicle is performed in a parking lot according to the embodiment of the present invention.

FIG. 6 is a still another top view of the parking lot for explaining how an automatic parking of the subject vehicle is performed in a parking lot according to the embodiment of the present invention.

FIG. 7 is a top view of a parking lot for explaining an outline of an automatic parking performed by an automatic parking control unit according to the embodiment of the present invention.

FIG. 8 is a flowchart illustrating a processing of an automatic parking performed by the automatic parking control unit according to the embodiment of the present invention.

FIG. 9 is a flowchart illustrating a processing of an automatic parking performed by the automatic parking control unit according to the embodiment of the present invention.

FIG. 10 is a flowchart illustrating details of a step of displaying a find screen according to the embodiment of the present invention.

FIG. 11 is a top view illustrating a parking lot in which candidate parking locations are displayed with respective degree of recommendations according to the embodiment of the present invention.

FIG. 12 is a top view illustrating a parking lot in which a parking available location as a non-candidate parking location is also displayed according to the embodiment of the present invention.

FIG. 13 a top view illustrating a parking lot in which parking spaces are arranged on a right and a left side according to the embodiment of the present invention.

FIG. 14 is a top view illustrating a parking lot in which a parking is performed in a manner similar to a perpendicular parking according to the embodiment of the present invention.

FIG. 15 is a top view illustrating a parking lot in which a parking is performed in a manner similar to a parallel parking according to the embodiment of the present invention.

### DETAILED DESCRIPTION OF THE EMBODIMENTS

An embodiment of the present invention is described with reference to the related drawings. In the description below, directions of front, rear, right, and left are as indicated by respective arrows in the drawings.

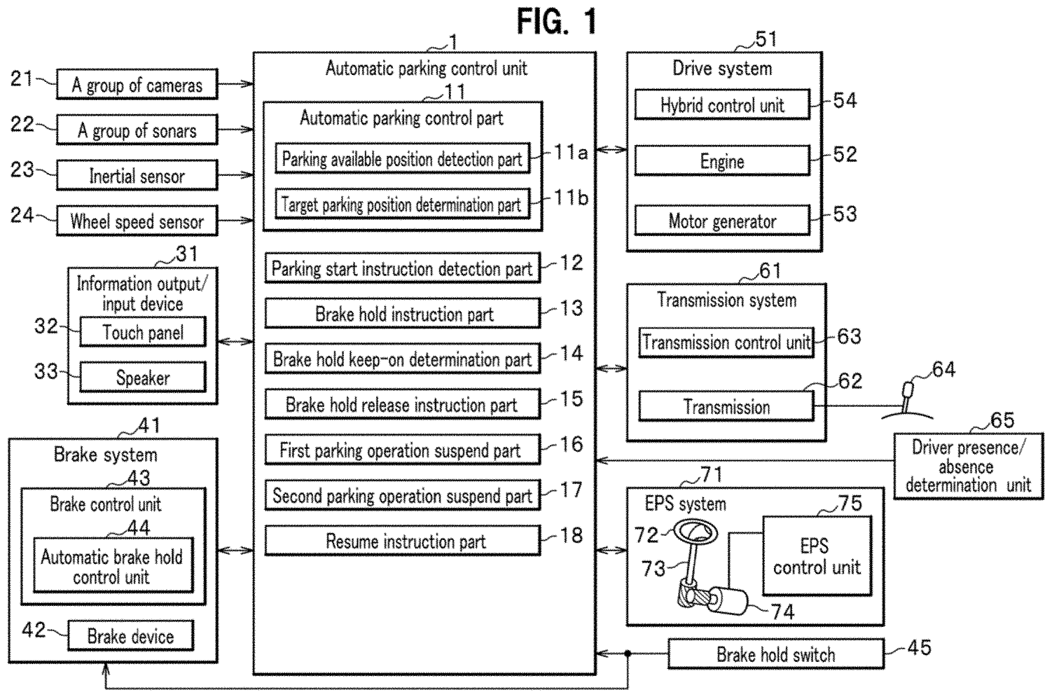

FIG. 1 a block diagram illustrating a system configuration focusing on an automatic parking control unit 1 according to the embodiment of the present invention.

The automatic parking control unit 1 serves as an automatic parking ECU (Electronic Control Unit) and realizes the parking assist device of the present invention. The automatic parking control unit 1 is structured to have a microcomputer as a main component thereof, based on a control program of which a processing is performed to realize respective functions of various control parts described below. The automatic parking control unit 1 performs a function of an automatic parking control part 11. The automatic parking control part 11 performs respective function of a parking available position detection part 11a and a target parking position determination part 11b.

The automatic parking control unit 1 also performs respective functions of a parking start instruction detection part 12, a brake hold instruction part 13, and a brake hold keep-on determination part 14. The automatic parking control unit 1 also performs respective functions of a brake hold release instruction part 15, a first parking operation suspend part 16, a second parking operation suspend part 17, and a resume instruction part 18. Details of processings performed by the respective parts will be described later.

The automatic parking control unit 1 is connected to each of a group of cameras 21 and a group of sonars 22. Each of the components connected to the automatic parking control unit 1 may have a direct connection thereto or may have an indirect connection thereto via a CAN (Controller Area Network) (the connection is shown by a line in the figure).

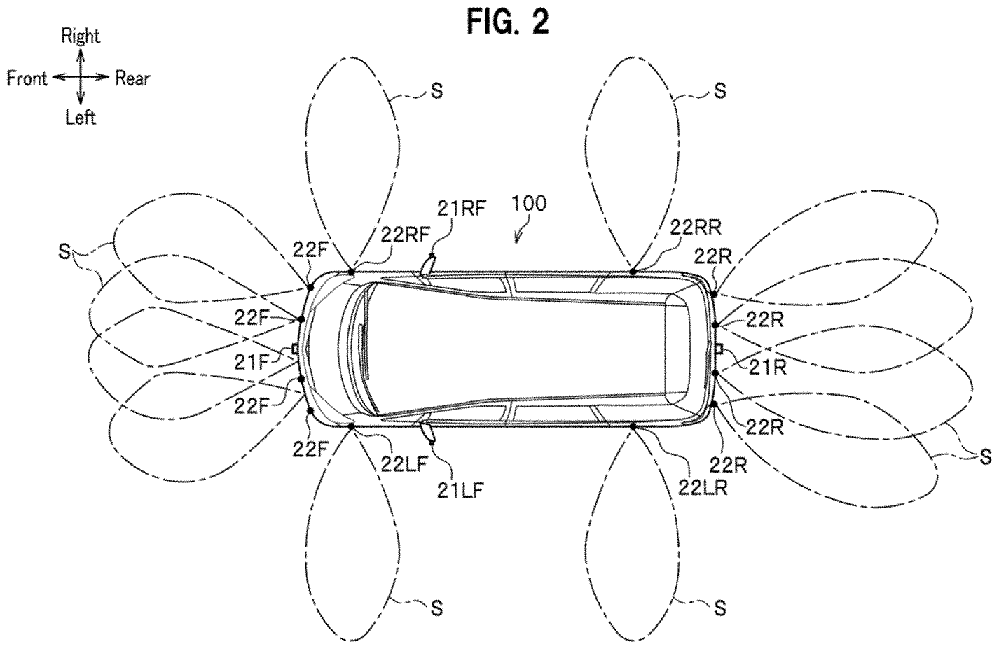

FIG. 2 is a top view illustrating at which position on a subject vehicle 100 each of the group of cameras 21 and the group of sonars 22 is mounted.

The automatic parking control unit 1 controls an automatic parking. The automatic parking control unit 1 thus detects a possible parking space for the subject vehicle 100 in a parking lot or the like, using information recognized by the group of cameras 21 and the group of sonars 22 (results of the recognition on surroundings of the subject vehicle 100).

The group of cameras 21 includes a plurality of cameras mounted on the subject vehicle 100. More specifically, the subject vehicle 100 is equipped with a front camera 21F which is disposed in a front part thereof and takes an image of an area ahead thereof. The subject vehicle 100 is equipped with a rear camera 21R which is disposed in a rear part thereof and takes an image of an area behind the subject vehicle 100.

The subject vehicle 100 is equipped with a side camera 21RF which is disposed in a front right part thereof and takes an image of an area on a right side thereof. The subject vehicle 100 is equipped with a side camera 21LF which is disposed in a front left part thereof and takes an image of an area on a left side thereof. The side cameras 21RF, 21LF may be preferably but not necessary be disposed at a tip of a door mirror or apart from the door mirror, because this can prevent the door mirror from being inconveniently captured in an image taken by the cameras. Alternatively, the side cameras 21RF, 21LF may be disposed at any other positions, keeping some respective distances from the door mirror.

The group of sonars 22 includes a plurality of sonars mounted in the subject vehicle 100. More specifically, the subject vehicle 100 is equipped with four units of the front sonars 22F which are disposed in the front part of the subject vehicle 100 and are arranged at substantially regular intervals therebetween. Each of the four front sonars 22F detects an obstacle ahead of the subject vehicle 100. The subject vehicle 100 is also equipped with four units of rear sonars 22R which are disposed in a rear part of the subject vehicle 100 and are arranged at substantially regular intervals therebetween. Each of the four rear sonars 22R detects an obstacle behind the subject vehicle 100. In other words, each of the front sonars 22F and each of the rear sonars 22R detect an obstacle in a forward and a backward travel directions of the subject vehicle 100, respectively.

Each of the side sonars 22RF, 22LF, 22RR, 22LR detects an obstacle which may be possibly hit by the subject vehicle 100. Each of a dash-dot-dash line S indicates a range of a space in which each of the sonars 22 can detect such an obstacle.

The subject vehicle 100 is equipped with a single unit of a side sonar 22RF in a front right lateral part thereof. The side sonar 22RF detects an obstacle present in a right lateral direction of the subject vehicle 100, from the front right part thereof.

The subject vehicle 100 is equipped with a single unit of a side sonar 22LF in a front left lateral part thereof. The side sonar 22LF detects an obstacle present in a left lateral direction of the subject vehicle 100, from the front left part thereof.

The subject vehicle 100 is equipped with a single unit of a side sonar 22RR in a rear right lateral part thereof. The side sonar 22RR detects an obstacle present in the right lateral direction of the subject vehicle 100, from the rear right part thereof.

The subject vehicle 100 is equipped with a single unit of a side sonar 22LR in a rear left lateral part thereof. The side sonar 22LR detects an obstacle present in the left lateral direction of the subject vehicle 100, from the rear left part thereof.

The number of units of the cameras or the sonars and respective mounted positions thereof are not limited to the described above. The number of units may be increased or reduced or the mounted positions may be changed, though the number of units of both the cameras and the sonars and the mounted positions thereof are preferably selected such that circumstances all around the subject vehicle 100 can be detected as much as possible. Alternatively, any sensors other than the cameras and the sonars may detect the surrounding of the subject vehicle 100.

For example, the group of sonars 22 mounted in the subject vehicle 100 are provided herein as an example of detection of a surrounding obstacle using echolocation. Instead, any other obstacle detection means may be used such as, for example, LIDAR (Light Detection and Ranging) which is a method of detecting an object by measuring a time required for detecting a scattered light reflected from an irradiated light. Another obstacle detection means is RADAR which is a method of detecting an object by irradiating an object with a radar wave (a laser, a microwave, a milliwave, a supersonic wave, or the like) and receiving the radar wave reflected by the object.

Referring back to FIG. 1, the automatic parking, control unit 1 is connected to each of an inertial sensor 23 and a wheel speed sensor 24. The inertial sensor 23 is a sensor used for detecting an acceleration of the subject vehicle 100. The wheel speed sensor 24 is a sensor used for detecting a wheel speed of each wheel of the subject vehicle 100.

The automatic parking control unit 1 is connected to an information output/input device 31. The information output/input device 31 includes a touch panel 32 and a speaker 33. A main body of the information output/input device 31 is disposed near a drivers seat such that a driver can operate the touch panel 32 or the like. The information output/input device 31: makes the touch panel 32 display information of various types; makes the speaker 33 output sound of various types; and allows the touch panel 32 receive operations of various types.

The information output/input device 31 can: display car navigation information created based on a satellite positioning system or the like, in the touch panel 32; and output the information from the speaker 33. The information may include information received from the VICS (Vehicle Information and Communication System).

The information output/input device 31 can: receive TV or sound broadcasting; and display a received image in the touch panel 32 or output a received sound from the speaker 33. The information output/input device 31: includes an optical disk device (not shown); and thereby plays a CD (Compact Disc), a DVD (Digital Video (Versatile) Disk), a BD (Blu-ray Disc), or the like. The information output/input device 31 may: include a HOD (Hard Disk Drive) (not shown); and reproduce sound such as a music stored therein.

The information output/input device 31 can also: send a message of various type received from the subject vehicle 100 or an instrument installed in the subject vehicle 100 (such as, for example, ETC: Electronic Toll Collection system); and receive an input of various types for operating the subject vehicle 100 or the instrument mounted therein, in the touch panel 32.

The automatic parking control unit 1 is connected to a brake system 41. The brake system 41 is a system for braking the subject vehicle 100. The brake system 41 includes: a brake device 42 which brakes the subject vehicle 100; and a brake control unit 43 which controls the brake device 42. The brake control unit 43 includes an automatic brake hold control unit 44. The automatic brake hold control unit 44 serves as an automatic brake hold controller. The brake device 42: generates a fluid pressure (a hydraulic pressure); supplies the generated fluid pressure to a wheel cylinder of each of wheels not shown; and thereby generates friction brake.

The brake system 41 may use both the above-described brake and a regenerative brake, if the subject vehicle 100 is a hybrid vehicle or the like. The brake device 42 is a device using, for example, a brake by wire system, which makes it possible to generate a braking force, regardless of an operation of a brake pedal (not shown). The brake device 42 may be a system with an electric brake booster installed therein. Even in this case, the electric brake booster can generate a braking force, regardless of an operation of a brake pedal (not shown). The brake control unit 43 is controller for controlling the brake device 42.

The automatic brake hold control unit 44 of the brake control unit 43 controls a function of an automatic brake hold in which, when a driver presses down a brake pedal (not shown), and then, even after the driver lifts his/her foot off the brake pedal, the braking state is maintained as it was. Note that the automatic brake hold function releases an automatic brake hold state, when a prescribed condition is satisfied, for example, when an accelerator pedal (not shown) is operated. The automatic brake hold state can be activated or released by operating a brake hold switch 45 which is disposed near the drivers seat of the subject vehicle 100.

The automatic parking control unit 1 is connected to the drive system 51. The drive system 51 is a system for making the subject vehicle 100 travel. In this embodiment, description is made assuming, an example in which the subject vehicle 100 is a hybrid vehicle and is equipped with an engine 52 and a motor generator 53 each as a driving source. The hybrid control unit 54 provides control over the engine 52 and the motor generator 53, to thereby make the subject vehicle 100 travel. The subject vehicle 100 is not, however, limited to a hybrid vehicle. For example, when the subject vehicle 100 is a gasoline-powered vehicle, only the engine 52 is a driving force. When the subject vehicle 100 is an electric-powered vehicle including a fuel cell vehicle, only a motor is a driving force.

The transmission system 61 is a system for shifting gears of the subject vehicle 100. The transmission system 61 includes: a transmission 62 which shifts gears of the subject vehicle 100, a transmission control unit 63 which controls the transmission 62; and a gearshift 64 which is connected to the transmission 62.

The transmission 62 used herein may be an automatic transmission or a manual transmission. In the transmission system 61 of the present invention, the transmission 62 can shift gears of the subject vehicle 100 under control provided by the transmission control unit 63, without control by a driver's operation. In this case, in response to shifting gears, the transmission control unit 63 makes the gearshift 64 variably operate a position thereof.

The automatic parking control unit 1 is connected to a driver presence/absence determination unit 65. The driver presence/absence determination unit 65 determines whether or not a driver is present in the driver's seat of the subject vehicle 100.

The automatic parking control unit 1 is connected to an EPS (Electric Power-Steering) system 71. The EPS system 71 assists a steering operation of a driver. The EPS system 71 includes: a steering shaft 73 to which a steering wheel 72 is attached; a drive motor 74 which rotatably drives the steering shaft 73; and an EPS control unit 75 which controls the drive motor 74. The EPS system 71 makes the steering shaft 73 rotate, using the drive motor 74 as a drive source, to thereby assist a steering operation of a driver who steers the subject vehicle 100 by rotating the steering wheel 72.

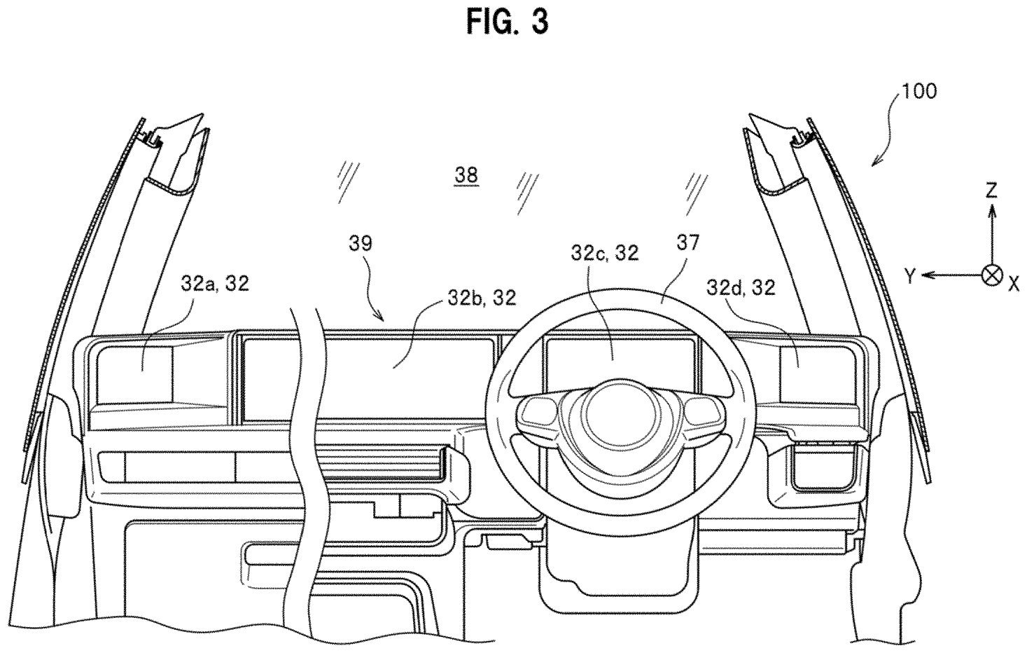

FIG. 3 is a diagram illustrating a structure of a front interior section of the subject vehicle 100.

The touch panel 32 (FIG. 1) of the subject vehicle 100; is a display device which displays information of various types for an occupant therein; and is also an input device which detects a touch therein and outputs information on a position of the touch to the automatic parking control unit 1.

The touch panel 32 used herein is not specifically limited and may be a LCD (Liquid Crystal Display), an organic EL (Electroluminescence) display, or the like. Or, the display device of the touch panel 32 may be a HUD (Head Up Display) which projects an appropriate image on a front windshield 38.

The speaker 33 (FIG. 1) outputs voice and sound. Any number of units of the speakers 33 may be disposed in any appropriate positions such as, for example, an instrument panel 39, a door panel, and a rear parcel shelf (the latter two of which are not shown) in the vehicle interior.

The instrument panel 39 of the touch panel 32 includes: a meter panel 32c which is disposed in an opposite position to the driver's seat across the steering wheel 37; a multi-information panel 32b which is horizontally long in a width direction of the subject vehicle 100 and is disposed in an opposite position to the driver's seat and a front passenger seat adjacent thereto; a right side panel 32d which is disposed on a side nearer the driver's seat in the vehicle width direction; and a left side panel 32a which is disposed on a side nearer the front passenger seat in the vehicle width direction. Another touch panel 32 may be disposed in an opposite position to a backseat (on a backside of a front seat).

The left side panel 32a displays therein information on a rearward and downward image on the left side of the subject vehicle 100 which is taken by the side camera 21LF disposed on the left side of the subject vehicle 100.

The multi-information panel 32b displays therein information of various types such as, for example: information on a map around the subject vehicle 100; information on a current location of the subject vehicle 100 on the map; traffic information on a road on which the subject vehicle 100 is currently traveling and is going to travel (including information on a traffic light); traffic participant information which is information on a traffic participant around the subject vehicle 100 (including a pedestrian, a bicycle, a motorcycle, and a vehicle other than the subject vehicle 100); and a message to a traffic participant.

The meter panel 32c displays therein, for example: information on a speedometer, a tachometer, an odometer, and a shift position; and information on a lighting condition of each light.

The right side panel 32d displays therein information on a rearward and downward image on the right side of the subject vehicle 100 which is taken by the side camera 21RF disposed on the right side of the subject vehicle 100.

As an input/output device for operating the automatic parking control unit 1, the information output/input device 31 (the touch panel 32 and the speaker 33) installed in the subject vehicle 100 may be used as described above. Or, any appropriate device physically separated from the subject vehicle 100 (such as a smartphone) may be used. That is, a signal of an output screen displayed in the touch panel 32 may be outputted from the automatic parking control unit 1 to a touch panel of a smartphone via a wireless radio communication such as Bluetooth (registered trademark).

As an input device for operating the automatic parking control unit 1, an in-vehicle mechanical switch (such as a dial switch) or a pointing device may be used.

A user who operates the above-described input/output device or the like is not limited to a driver of the subject vehicle 100. An occupant in a front passenger seat or even outside of the subject vehicle 100 may operate such an input/output device.

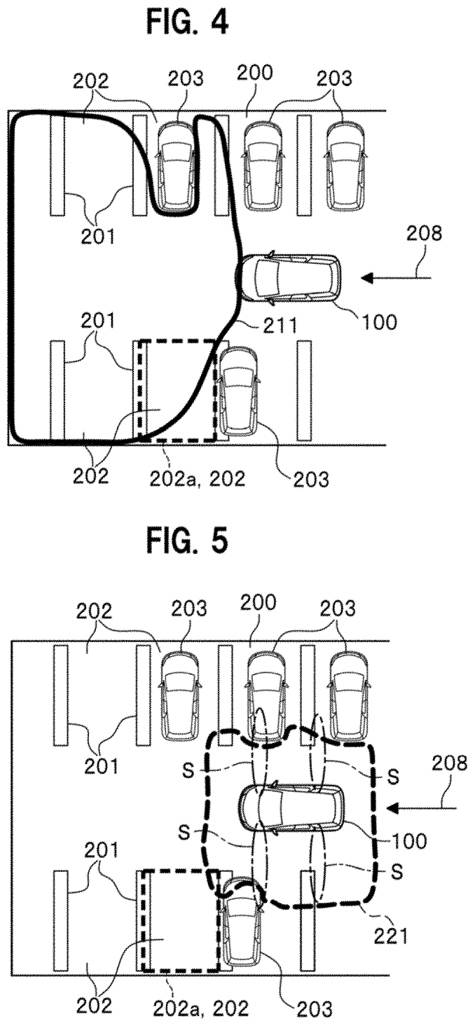

FIG. 4 to FIG. 6 are each a top view of a parking lot for explaining how an automatic parking of the subject vehicle 100 is performed.

In FIG. 4, the subject vehicle 100 mainly uses the front camera 21F of the group of cameras 21 to find a parking place in a parking lot 200.

When the subject vehicle 100 enters the parking lot 200, there are a plurality of parking spaces 202 marked out with white lines 201 are arranged on both sides of the subject vehicle 100. A vehicle 203 other than the subject vehicle 100 is already parked in one of the parking spaces 202. No vehicle is parked in another parking space 202. A driver of a vehicle entering the parking lot 200 travels in a direction indicated by an arrow 208, while reducing a speed thereof.

The subject vehicle 100 can recognize an area 211 as a space available for parking, based on an image taken by the front camera 21F. More specifically, the subject vehicle can recognize a difference in luminance by performing a prescribed image processing of the image taken by the front camera 21F. Such camera recognition is good at recognition of the white line 201 and has a space recognition function, too. The camera recognition is not, however, good at recognition of snow, a white wall, other vehicle present very close to the subject vehicle 100 itself, and the like. Therefore, just by using the image taken by the front camera 21F, the subject vehicle 100 cannot perform an appropriate brake control to avoid an obstacle, which is required for performing an automatic parking.

In FIG. 5, the subject vehicle 100 finds a parking space thereof in the parking lot 200 using each of the group of sonars 22.

The sonar 22 transmits and receives a sound wave to detect an obstacle and is good at detection of an obstacle present very close to the subject vehicle 100 itself, at which a camera is not good. The sonar 22 is thus necessary to perform an accurate brake control to avoid an obstacle. The sonar 22 also has a higher space recognition than that of a camera, which works for providing various parking patterns. An area 221 illustrates an area recognized as available for parking by the group of sonars 22.

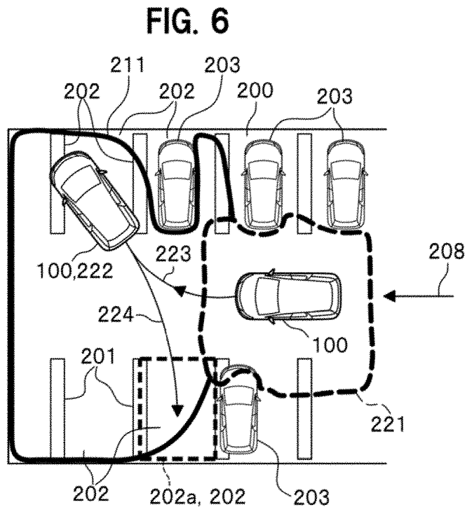

In FIG. 6, the subject vehicle 100 uses both the front camera 21F (which recognizes the area 211) and the group of sonars 22 (which recognizes the area 221), to thereby recognize a larger combined space as available for parking thereof. This facilitates the break control to avoid an obstacle.

The subject vehicle 100 herein determines the parking space 202a as a parking space thereof. The subject vehicle 100 also recognizes that there is an empty space diagonally forward right when viewed therefrom; and determines to make a three point turn at the space. This means that an automatic parking control is possible such that the subject vehicle 100: travels forward; makes a three point turn by a steering wheel operation to the right; stops at a three point turn location 222 (an arrow 223); and makes another three point turn to travel backward into the parking space 202a (an arrow 224).

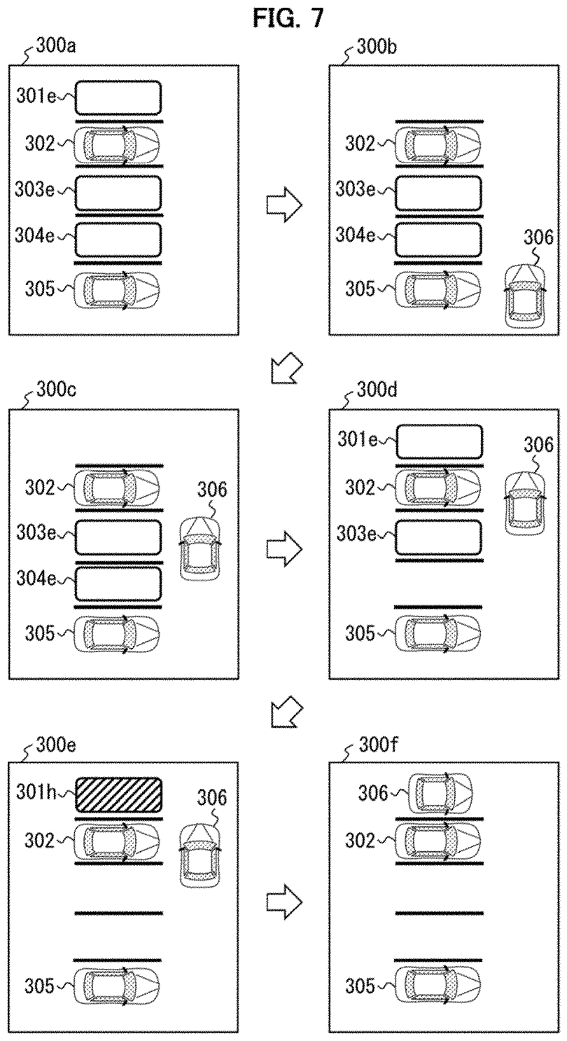

The automatic parking has been described above with reference to FIG. 4 to FIG. 6. Next is described with reference to FIG. 7, an outline of a display control in which displayed contents of a parking available location is appropriately narrowed down in accordance with a current location of the subject vehicle 100, which is one of the main features of this embodiment.

FIG. 7 is a top view illustrating a parking lot for explaining an outline of an automatic parking performed by the automatic parking control unit 1. The top view includes a state 300a, a state 300b, a state 300c, a state 300d, a state 300e, and a state 300f, and time proceeds in this order.

The state 300a shows a state before the subject vehicle 100 arrives at a parking lot. The parking lot has five parking spaces. Of the five parking spaces, a first parking space 301e, a third parking space 303e, and a fourth parking space 304e in an order from top to bottom with respect to the plane of the figure are empty (the last character “e” of each of the reference numerals indicates “empty”). Meanwhile, a second parking space 302 and a fifth parking space 305 in the order same as described above are parked by other vehicles.

Let a vacant parking space such as the first parking space 301e, the third parking space 303e, and the fourth parking space 304e be herein called a “parking available location”. As described above with reference to FIG. 4 to FIG. 6, the parking available position detection part 11 a detects one or more parking available locations.

The state 300b shows a state in which the subject vehicle 100 advances to a current location thereof 306 which is near an entrance of the parking lot. The target parking position determination part 11b of the subject vehicle 100: detects the three parking available locations illustrated in the state 300a; narrows down the three parking available locations to an appropriate number of the parking available locations each of which is situated close to the current location thereof 306 (in this case, two parking available locations) (namely, the third parking space 303e and the fourth parking space 304e); and notifies a driver of the narrowed down parking available locations. That is, the state 300b also represents a screen display viewed by a driver.

Let a parking available location selected based on the current location thereof 306 be herein called a “candidate parking location.” The “candidate” used herein means a candidate for a final location in which the subject vehicle 100 performs an automatic parking.

The state 300c is a state in which the current location 306 illustrated in the state 300b is moved slightly forward. In other words, the driver of the subject vehicle 100 appropriately presses an accelerator to make the subject vehicle 100 travel at a very low speed. In this state, the candidate parking locations close to the current location 306 are still the same, the third parking space 303e and the fourth parking space 304e.

The state 300d is a state in which the current location 306 illustrated in the state 300c is moved further slightly forward. In the state 300d, the current location 306 goes away from the fourth parking space 304e and comes close to the first parking space 301e. The target parking position determination part 11b thus: excludes the fourth parking space 304e as the candidate parking location; newly adds the first parking space 301e; and updates a screen display of the candidate parking locations.

The state 300e is a state in which the driver selects a target parking location at the current location 306 in the state 300d. The driver operates a brake and stops the subject vehicle 100 at the current location 306 with an intention of parking in the first parking space 301e or in the third parking space 303e. The driver then touches the first parking space 301e in the screen display of the state 300d, to thereby select a target parking location. Upon the selection, the target parking position determination part 11b changes a display of the first parking space 301e to a target parking location display 301h. From this point, a brake hold of the subject vehicle 100 is switched from a manual one performed by the driver to an automatic one performed by the automatic parking control part 11.

The state 300f is a state in which the subject vehicle 100 is automatically parked in the target parking location by means of automated driving (that is, an automatic parking has been completed). A current location 306 of the subject vehicle 100 is moved to the target parking location display 301h selected at the state 300e. The automatic parking is performed as described above with reference to FIG. 6.

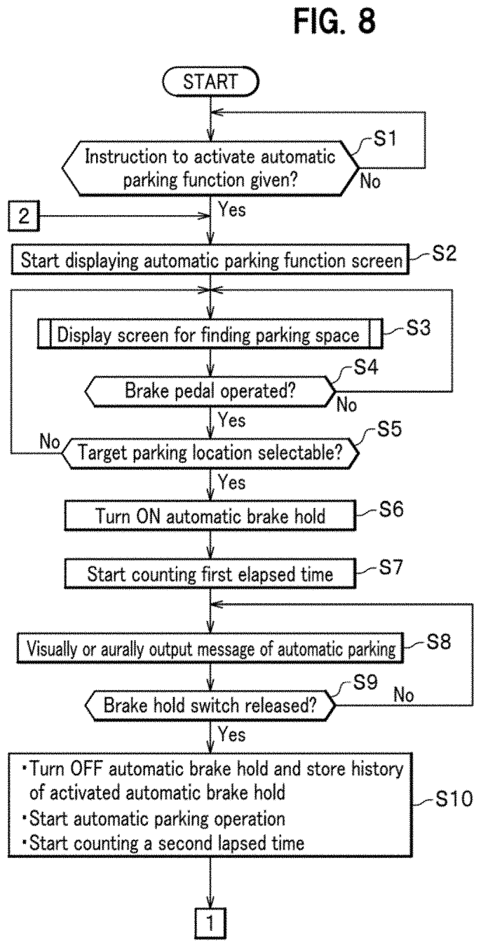

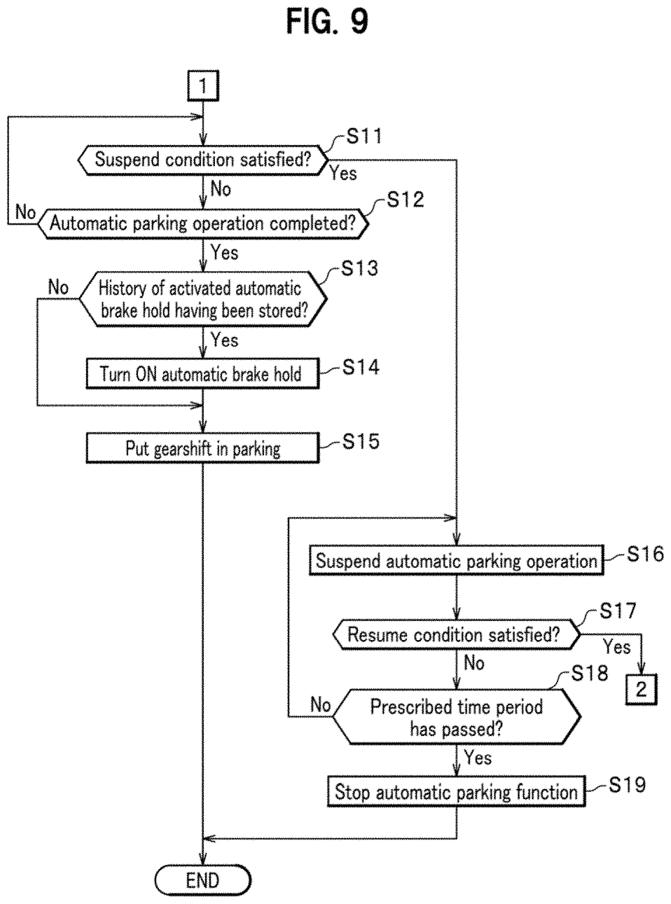

FIG. 8 combined with FIG. 9 are a flowchart illustrating a processing of an automatic parking performed by the automatic parking control unit 1. FIG. 8 and FIG. 9: illustrate a series of steps constituting the processing; and are linked at respective terminals 1 and 2.

A driver drives the subject vehicle 100 and enters the parking lot 200 in the direction indicated by the arrow 208. At this time, the driver operates the touch panel 32 or the like, near an entrance of the parking lot 200, to thereby give an instruction to activate an automatic parking function (Yes in S1). The parking start instruction detection part 12: receives the instruction of activation of the automatic parking function; and thereby displays a prescribed automatic parking function screen in the touch panel 32 (S2). The automatic parking function screen appropriately varies depending on the necessity. The parking available position detection part 11a of the automatic parking control part 11 displays, as illustrated in FIG. 7, a screen for finding a parking space with respect to a current location of the subject vehicle 100, in the touch panel 32 (S3).

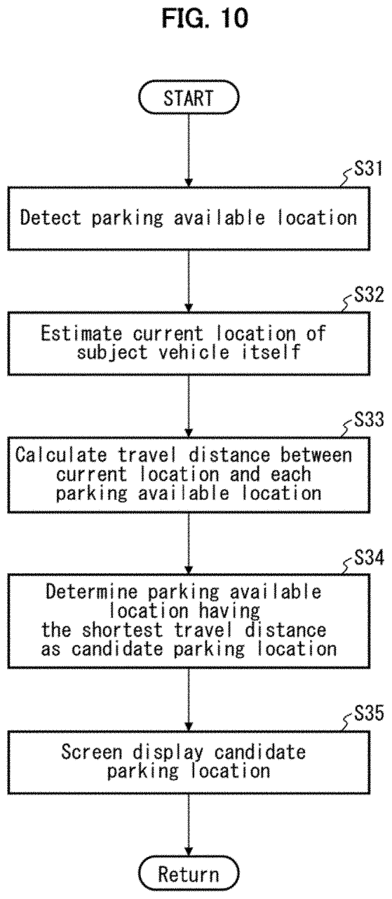

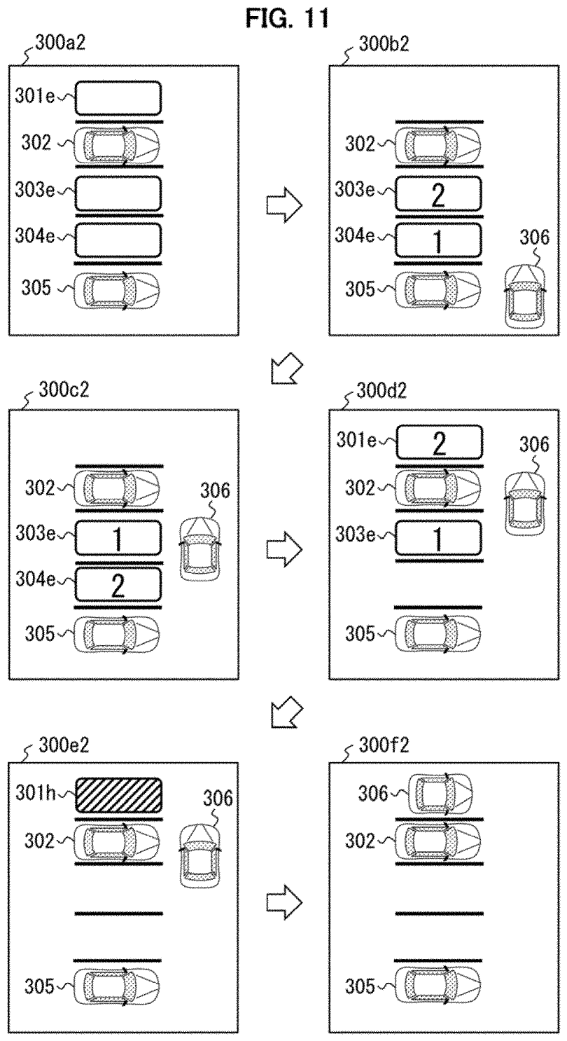

FIG. 10 is a flowchart illustrating details of the step of displaying a find screen (S3).

In S31, the parking available position detection part 11a detects one or more parking available locations, using both the front camera 21F and the group of sonars 22, by means of the technique illustrated in FIG. 4 to FIG. 6.

In S32, the target parking position determination part 11b estimates a current location of the subject vehicle 100 itself, based on a result detected by the inertial sensor 23 and the wheel speed sensor 24.

In S33, the target parking position determination part 11b calculates a travel distance of the subject vehicle 100 required for parking in each of the detected parking available locations, based on the current location thereof estimated in S32. The current location as a reference point (a starting point from which a travel distance is measured) is, for example, a driver's eye point (an eye position of a driver sitting in a driver's seat. The travel distance used herein may be a distance in a straight line between the current location and the parking available location. Alternatively, the target parking position determination part 11b may: calculate a route on which the subject vehicle 100 can travel from the current location thereof to the parking available location, while avoiding an obstacle based on the result detected by the front camera 21F and the group of sonars 22; and take a length of the route as a travel distance.

In S34, the target parking position determination part 11b determines one of the parking available locations having the shortest travel distance, as a candidate parking location. Note that each of the current location and the candidate parking location changes from moment to moment, along with traveling of the subject vehicle 100.

The target parking position determination part 11b may determine, for example, a prescribed number (two in FIG. 7) of parking available locations in ascending order of distance from the current location of the subject vehicle 100, as candidate parking locations. Or, the target parking position determination part 11b may determine a prescribed number or a smaller number (one, for example) of parking available locations each having a travel distance not more than a prescribed one, as candidate parking location.

In S35, the target parking position determination part 11b displays a positional relation between the current location and each of the candidate parking locations determined in S34, in the touch panel 32 (the multi-information panel 32b in FIG. 3). In order to display the candidate parking location more clearly to the driver, it is preferable to surround the candidate parking location with a frame or any other mark in the display.

Referring back to FIG. 8, after Yes in S1, the driver drives the subject vehicle 100 and travels into the parking lot 200, during which the find screen display step (S3) is repeated (No in S4). This means that, even when the subject vehicle 100 is traveling around, contents displayed in the screen are continued to be updated, based on the latest current location.

That is, upon update of a current location of the subject vehicle 100 along with a traveling thereof, the parking available position detection part 11a detects an updated parking available location, based on updated recognition information. The target parking position determination part 11b then: extracts an updated candidate parking location based on a distance between the updated current location and each of the updated parking available locations; and updates contents displayed in a display device with the extracted candidate parking location.

Let us assume a case in which the driver operates a brake pedal (not shown) (if Yes in S4) and thereby stops the subject vehicle 100. At this time, when any occupant of the subject vehicle 100 operates the touch panel 32 and selects one of candidate parking locations in S35 as a target parking location (if Yes in S5), the target parking position determination part 11b determines the selected candidate parking location as the target parking location.

Selection from the target parking locations can be made by, for example, touching an area representing a candidate parking location desired by any occupant. The area is surrounded by a frame or the like in the touch panel 32. When any target parking location is not yet selected (if No in S5), the processing repeats S3. Note that herein, the subject vehicle 100 stops, and then, any target parking location is selected (S4→S5). S4 and S5 may be, however, performed in an inverse order.

The target parking position determination part 11b; calculates a route from a current location of the subject vehicle 100 to the target parking location, based on a positional relation between the target parking location selected in S5 and the current location, using the technique shown in S33 or the like; and determines the calculated route as a “target travel route” to be used in an automatic parking.

The brake hold instruction part 13 gives the automatic brake hold control unit 44 an instruction to turn ON an automatic brake hold function (S6). The automatic brake hold control unit 44 realizes an automatic brake hold controller, by which, even when a driver lifts his/her foot off a brake pedal (not shown), a brake state of the subject vehicle 100 is automatically maintained.

After that, a second parking operation suspend part 17 starts counting an elapsed time (a first elapsed time), using a timer thereof (S7). The automatic parking control part 11 then: displays a message on an automatic parking in the touch panel 32; and also plays an appropriate speech message, using the speaker 33 (S8). Alternatively, only a message on the automatic parking may be displayed in the touch panel 32. Such a message for a driver of the subject vehicle 100 is, for example, “Automatic brake hold is turned ON. If you want to start an automatic parking, you can press down a brake hold switch, keep your hands off the steering wheel, and lift your foot off the brake pedal”.

If the driver carries out all of what the message has said, the brake hold switch 45 is pressed down, to thereby release the brake hold switch 45 (if Yes in S9). The press-down of the brake hold switch 45 herein serves as a manipulation of a release instruction operation part. If the brake hold switch 45 is not released (If No in S9), the touch panel 32 keeps on displaying the message in S8.

If a prescribed operation is performed at some point during the steps described above (S2 to S8), the processing of automatic parking is stopped. The prescribed operation includes, for example: that the driver inputs an operation of stopping the automatic parking function on an automatic parking function screen displayed in the touch panel 32; and that the driver intentionally moves the gearshift 64.

If the brake hold switch 45 is released (if Yes in S9), the processing performs S10. That is, the brake hold release instruction part 15 gives the automatic brake hold control unit 44 an instruction to turn OFF the automatic brake hold function (S10), which releases brakes of the subject vehicle 100. In S6, the brake hold keep-on determination part 14 stores a history that the automatic brake hold function has been activated, in a nonvolatile memory or the like (S10). The automatic parking control part 11 starts an automatic parking operation (contents of the operation will be described hereinafter) (S10). The second parking operation suspend part 17 starts counting a lapsed time (a second lapsed time), using a timer thereof (S10). Note that, if a brake pedal (not shown) is not operated, the automatic parking control part 11 provides control as follows. The automatic parking control part 11 does not perform the automatic parking operation (S10), even when the brake hold switch 45 is released (S9). In this case, however, the automatic brake hold function (S6) still remains turned ON.

The automatic parking operation started by the automatic parking control part 11 are as follows. The automatic parking control part 11 provides control such that the subject vehicle 100 travels on the target travel route determined in S5. More specifically, the automatic parking control part 11 provides control over the brake system 41, the drive system 51, the transmission system 61 and the EPS system 71. Under the control, the subject vehicle 100 backs into the parking space 202a as a target parking location.

The automatic parking control part 11 controls the above-described systems such that the subject vehicle 100: travels in drive in a forward direction indicated by the arrow 223; and stops at the three point turn location 222. The automatic parking control part 11 then makes the subject vehicle 100: travel in reverse backward into the parking space 202a as the target parking location; and finally stop.

After the automatic parking operation is started (S10), the automatic parking control part 11 determines whether or not any suspend condition is satisfied, which is a condition to suspend an automatic parking function during the automatic parking operation (S11 in FIG. 9).

In S11 the suspend condition is satisfied when, for example, the steering wheel 72 is operated, or the gearshift 64 is put in neutral, or the like.

In S11, the second parking operation suspended part 17 determines whether or not the first elapsed time of which counting has started in S7 is equal to or longer than a prescribed time period. The prescribed first elapsed time is a time period from when a target parking location is determined (S5 and S7) until when an operation of the brake hold switch 45 for releasing an automatic brake hold is received (Yes in S9). The suspend condition also includes that the first elapsed time is equal to or longer than a prescribed time period. In S11, the second parking operation suspend part 17 determines whether or not the second lapsed time of which counting is started in S10 is equal to or longer than a prescribed time period. The second lapsed time is a time period from when the brake hold switch 45 is operated (Yes in S9) until when a release of a brake pedal (not shown) operation is detected. The suspend condition also includes that the second elapsed time equal to or longer than a prescribed time period.

The suspend condition also includes that the driver presence/absence determination unit 65 determines that any driver is not present in a driver's seat of the subject vehicle 100. The driver presence/absence determination unit 65 can be realized by, for example: a seating sensor which detects whether or not any driver is present in a driver's seat of the subject vehicle 100; a vehicle-mounted camera which takes an image of a vehicle interior thereof (based on an image processing of the taken image, whether or not any driver is present in the driver's seat can be determined); and a door opening sensor which detects whether or not a door of the driver's seat is opened. The suspend condition may include any other conditions under which the automatic parking function should be suspended.

If no suspend condition is present and the automatic parking operation has been completed (if Yes in S12), the touch panel 32, the speaker 33, or the like provides an appropriate output notifying that the automatic parking operation has been successfully completed, and the processing advances to S13. If any suspend condition is satisfied during the automatic parking operation (If No in S12), the processing advances to S16.

In S13, the brake hold keep-on determination part 14 determines whether or not any history that the automatic brake hold function has been activated is stored in S10. If any history is stored (if Yes in S13), the brake system 41 is again controlled such that the automatic brake hold is turned ON, and the processing advances to S15. Thus, even when the driver is not pressing down the brake pedal (not shown), the subject vehicle 100 is braked and is stopped. If no history has been stored (if No in S13), the processing advances to S15. In this case, the automatic brake hold function still remains to be OFF. A case as described above in which no history that the automatic brake hold function has been activated is stored in S10 is as follows: even when the automatic brake hold function is turned ON in S6, a driver operates the brake hold switch 45 such that the function is turned OFF. In S15, the automatic parking control part 11: provides control such that the gearshift 64 is put in parking; and terminates the automatic parking.

In S16, a suspend condition of the automatic parking is satisfied (if Yes in S11), the automatic parking function is thus terminated, and it is the determined whether or not any resume condition of resuming the automatic parking is satisfied (S17). The resume condition includes, for example, that a driver manipulates a resume switch on an automatic parking function screen (not shown) in the touch panel 32 such that the automatic parking be resumed. Meanwhile, if the driver manipulates a stop button on the automatic parking function screen, a stop of the automatic parking function is selected.

If any resume condition is satisfied (if Yes in S17), the processing returns to S2 in FIG. 8, and the automatic parking function is resumed. If a prescribed period of time has passed without satisfying any resume condition (if No in S17 and Yes in S18), the automatic parking function is stopped (S19), and the processing terminates. If the prescribed period of time has not yet passed without satisfying a resume condition (if No in S17 and No in S18), the processing returns to S16. Note that, if the stop button on the automatic parking function screen is manipulated, the automatic parking function is stopped without waiting for a lapse of the prescribed time period (Yes in S18).

Note that, when any suspend condition is satisfied (if Yes in S11) if the above-described resume condition is also satisfied (if Yes in S17), the automatic parking function can be resumed at S2. Meanwhile, if the suspend condition is satisfied during a series of operations of the automatic parking function, an entire processing of the automatic parking is stopped and will not be resumed. If the processing of the automatic parking is desired to be resumed, the processing is restarted at S1.

The “suspend condition” includes that, for example: the gearshift 64 is put in parking during a series of operations of the automatic parking function; an electric parking brake is operated; and the touch panel 32 or the like is operated to give an instruction to activate the automatic parking function. Note that, if any stop condition is satisfied during a series of the operations of the automatic parking function, the operations of the automatic parking function are stopped. In this case, however, if the stop condition is released, the operations of the automatic parking function are resumed at a point at which the operations have been suspended. The “stop condition” includes, for example, that a brake pedal (not shown) is operated.

Details of how the automatic parking control unit 1 controls the automatic parking function have been described above. Note that basic contents of a parking space finding, a target route computation, a vehicle control in performing an automatic parking, and the like, are known in the above-described Patent Documents 1 and 2.

It will be easily understood that the present invention is not limited to the above-described embodiment. Description above has been made by taking an example in which, for example, an automatic parking operation is performed by backing into a parking lot. The automatic parking may be, however, performed by head-in parking with the front of the subject vehicle 100 first. Another configuration may also be possible in which a driver can choose between a head-in and a reverse parking.

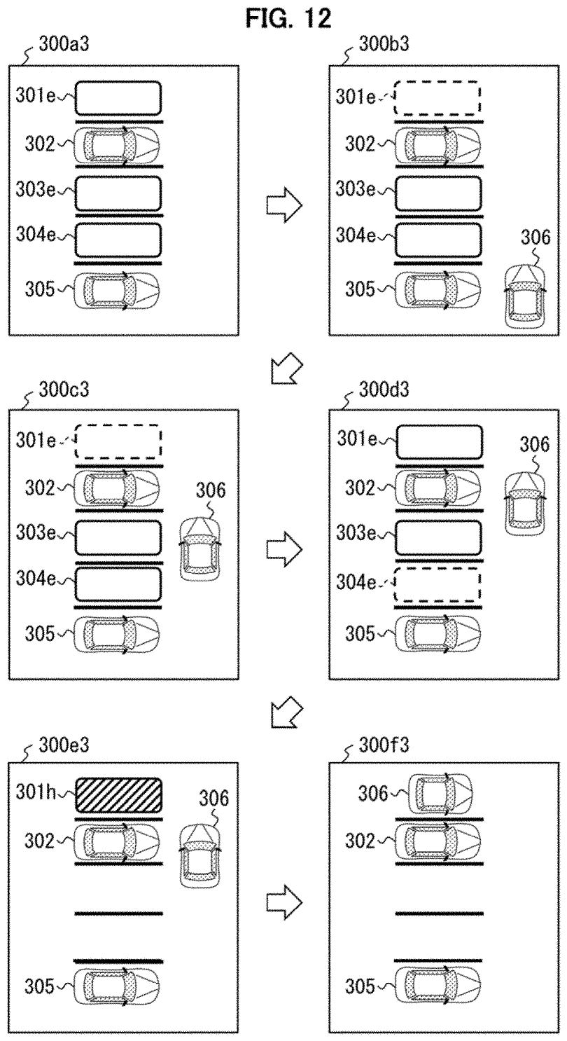

As illustrated in FIG. 11 to FIG. 15, variations of the processing of displaying a find screen (S3) may be used in which displayed contents of parking available locations are appropriately narrowed down in accordance with a current location of the subject vehicle 100.

FIG. 11 is a top view illustrating a parking lot in which candidate parking locations are displayed with respective degree of recommendations. In addition to the displayed contents illustrated in FIG. 7, the top view displays a serial number in a descending order of degrees of recommendations which is given according to a distance from the nearest to the the farthest from the current location 306 of the subject vehicle 100, such as the third parking space 303e with “degree of recommendations=1” and the fourth parking space 304e with “degree of recommendations=2”, in the state 300b2.

FIG. 12 is a top view illustrating a parking lot in which a parking available location as a non-candidate parking location is also displayed. In addition to the displayed contents illustrated in FIG. 7 (the candidate parking locations), the top view displays a parking available location which has not been selected as a candidate parking location. In the state 300b3, a parking available location as a non-candidate parking location, such as the first parking space 301e, is non-emphasis displayed with a dashed rectangle, so as to distinguish from a candidate parking location.

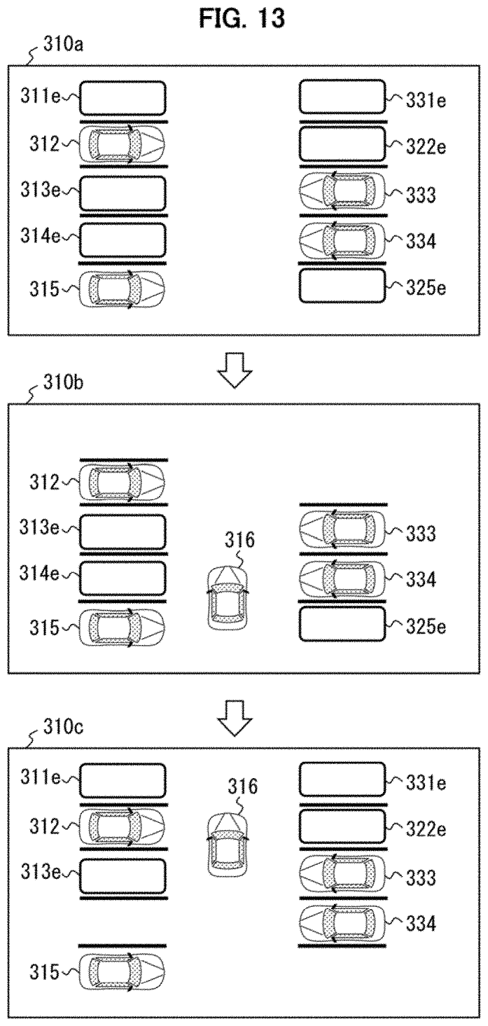

FIG. 13 a top view illustrating a parking lot in which parking spaces are arranged on a right and a left side. The top view includes a state 310a, a state 310b, and a state 310c, and time proceeds in this order.

The parking space on the left side includes: a vacant first parking space 311e; an occupied second parking space 312; a vacant third parking space 313e; a vacant fourth parking space 314e; and an occupied fifth parking space 315, in an order from top to bottom with respect to the plane of the figure.

The parking space on the right side includes: a vacant first parking space 321e; a vacant second parking space 322e; an occupied third parking space 323; an occupied fourth parking space 324; and a vacant fifth parking space 325e, in the order from top to bottom with respect to the plane of the figure.

The target parking position determination part 11b screen-displays up to two candidate parking locations, as illustrated in FIG. 7, for each of the right and left parking spaces, separately. That is, up to four candidate parking locations (up to two on the left side, which may also be referred to as a first prescribed number of candidate parking locations, plus up to two on the right side, which may also be referred to as a second prescribed number thereof) can be displayed.

Though up to four candidate parking locations can be displayed as described above, the target parking position determination part 11b does not, however, always screen-display four candidate parking locations. In the state 310b, for example, the target parking position determination part 11b screen-displays: two candidate parking locations (the third parking space 313e and the fourth parking space 314e) closer to a current location 316 of the subject vehicle 100 from among the three parking available locations on the left side; and one candidate parking location (the fifth parking space 325e) closer to the current location 316 from among the three parking available locations on the right side.

In the state 310c, meanwhile, the current location 316 is moved upward. In response, the target parking position determination part 11b screen-displays: the candidate parking locations on the left side different from those in the state 310b (the fourth parking space 314e is removed and the first parking space 311e is newly added); and the candidate parking locations on the right side also different from those in the state 310b (the fifth parking space 325e is removed and the first parking space 321e and the second parking space 322e are newly added), That is, in the state 310c, four candidate parking locations are screen-displayed.

As described above, the number of displayed candidates for each of those on the right and the left side is appropriately narrowed down. This makes it possible to let a user know in which candidate parking locations the subject vehicle 100 can be parked in an easy-to-understand manner.

The parking lot described above with reference to each of related figures up to FIG. 13 has parking spaces marked out with white lines for a perpendicular parking. The parking available position detection part 11a can thus detect a parking available location as a rectangle oriented in the same direction, that is, a horizontally-long rectangle with respect to the plane of the figure.

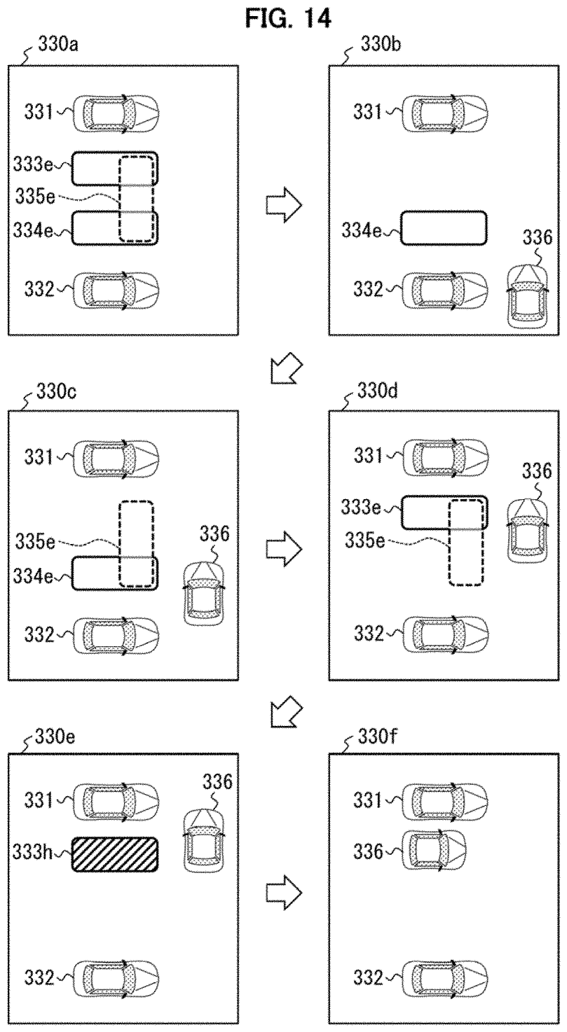

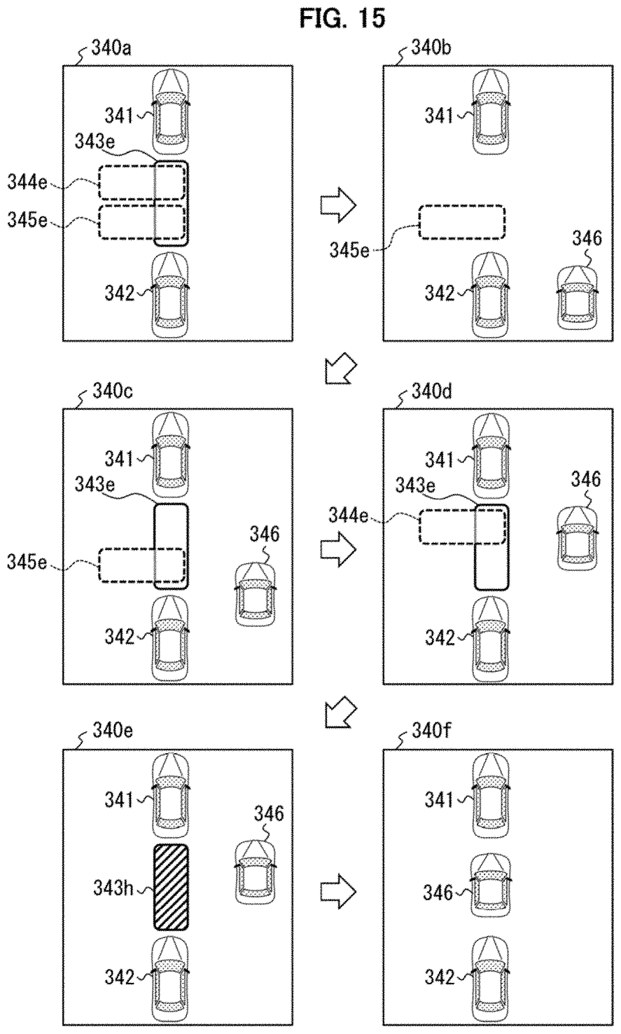

There is, however, a parking, lot which is, for example, a large empty space in which there is no specific parking rule such as white lines. There may be another parking lot having partially vanished white lines. In this case, the parking available position detection part 11a may detect a plurality of patterns of parking available locations as rectangles oriented in a plurality of directions (for example, a horizontal and a lengthwise direction). FIG. 14 and FIG. 15 are each a top view illustrating a parking lot in which there is no specific parking rule. When a plurality of parking available locations having respective parking orientations different from each other are detected, a step-by-step approach is displayed based on a current location of the subject vehicle 100, to thereby propose an appropriate parking space to the subject vehicle 100.

FIG. 14 is a top view illustrating a parking lot in which a parking is performed in a manner similar to the perpendicular parking. The top view includes a state 330a, a state 330b, a state 330c, a state 330d, a state 330e, and a state 330f, and time proceeds in this order.

In the state 330a, before the subject vehicle 100 arrives at a parking lot, two vehicles 331, 332 are already parked therein, and there is a substantially large parking space therebetween. The parking available position detection part 11a detects three parking available locations, namely, a first parking space 333e, a second parking space 335e, and a third parking space 334e. The second parking space 335e is a parking available location oriented in a direction orthogonal to those of the vehicles 331, 332.

As the current location 336 of the subject vehicle 100 is moved from downward to upward in the parking lot with respect to the plane of the figure, a candidate parking location or locations close to the current location 336 are changed as follows.

In the state 330b, only the third parking space 334e is displayed as the candidate parking location.

In the state 330c, the third parking space 334e and the second parking space 335e are displayed as the candidate parking locations.

In the state 330d, the first parking space 333e and the second parking space 335e are displayed as the candidate parking locations.

In the state 330e, a driver of the subject vehicle 100 selects the first parking space 333e as the target parking location. Upon the selection, the first parking space 333e is displayed differently as a target parking location 333h.

Note that, in the state 330c or the state 330d, two different parking spaces as the candidate parking locations may in some cases overlap each other. In the state 330d, for example, a right-hand section of the horizontally-oriented first parking space 333e is overlapped with an upper section of the longitudinal second parking space 335e. If the overlapped section is touched in selecting a target parking location, the target parking position determination part 11b displays another screen (not shown) on which selection of either of the two target parking locations is prompted.

In the state 330f, the current location 336 is moved into the first parking space 333e by an automatic parking.

The target parking position determination part 11b: groups the parking available locations into different patterns according to orientations of the parking spaces; and displays the different patterns in different display patterns.

Each of the first parking space 333e and the third parking space 334e: is horizontally oriented which is referred to as a first pattern; and is displayed in a first display pattern which is displayed as a solid rectangle for emphasis.

The second parking space 335e: is longitudinal which is referred to as a second pattern; and is displayed in a second display pattern which is displayed as a dashed rectangle for non-emphasis.

The target parking position determination part 11b may emphasize either of the first display pattern and the second display pattern. For example, either of the two patterns having more parking available locations than the other may be emphasized. Or, either of the two patterns having a parking orientation same as those of the vehicles 331, 332 (in the horizontal direction in the figure) may be emphasized.

This facilitates the subject vehicle 100 to perform the perpendicular parking (the first pattern) after the vehicles 331, 332, thus allowing a space-efficient parking even in a place where there is no explicit parking rule using white lines or the like.

FIG. 15 is a top view illustrating a parking lot in which a parking is performed in a manner similar to a parallel parking. The top view includes a state 340a, a state 340b, a state 340c, a state 340d, a state 340e, and a state 340f, and time proceeds in this order.

In the state 340a, before the subject vehicle 100 arrives at the parking lot, two vehicles 341, 342 are already parked therein, and there is a substantially large parking space therebetween. The parking available position detection part 11a then detects three parking available locations, namely, a first parking space 344e, a second parking space 343e, and a third parking space 345e. Each of the first parking space 344e and the third parking space 345e is a parking available location oriented in a direction orthogonal to those of the vehicles 341, 342.

As the current location 346 of the subject vehicle 100 is moved from downward to upward in the parking lot with respect to the plane of the figure, a candidate parking location or locations close to the current location 346 are changed as follows.

In the state 340b, only the third parking space 335e is displayed as the candidate parking location.

In the state 340c, the third parking space 345e and the second parking space 343e are displayed as the candidate parking locations.

In the state 340d, the first parking space 344e and the second parking space 343e are displayed as the candidate parking locations.

In the state 340e, a driver of the subject vehicle 100 selects the second parking space 343e as the target parking location. Upon the selection, the second parking space 343e is displayed differently as a target parking location 343h.

In the state 340f, the current location 346 is moved into the second parking space 343e by an automatic parking.

The target parking position determination part 11b: groups the parking available locations into different patterns according to orientations of the parking spaces.

The second parking space 343e: is horizontally oriented which is referred to as a first pattern; and is displayed in a first display pattern as a solid rectangle for emphasis.

Each of the first parking space 344e and the third parking space 345e: is longitudinal which is referred to as a second pattern; and is displayed in a second display pattern as a dashed rectangle for non-emphasis.

This facilitates the subject vehicle 100 to perform the perpendicular parking (the first pattern) after the vehicles 341, 342, thus allowing a space-efficient parking even in a place where there is no explicit parking rule using white lines or the like.

### DESCRIPTION OF REFERENCE NUMERALS

1 automatic parking control unit (parking assist device)
11 automatic parking control part
11a parking available position detection part
11b target parking position determination part
12 parking start instruction detection part
13 brake hold instruction part
14 brake hold keep-on determination part
15 brake hold release instruction part
16 first parking operation suspend part
17 second parking operation suspend part
18 resume instruction part
21 group of cameras
22 group of sonars
23 inertial sensor
24 wheel speed sensor
31 information output/input device
32 touch panel
33 speaker
41 brake system
42 brake device
43 brake control unit
44 automatic brake hold control unit
45 brake hold switch
51 drive system
52 engine
53 motor generator
54 hybrid control unit
61 transmission system
62 transmission
63 transmission control unit
64 gearshift
65 driver presence/absence determination unit
71 EPS system
72 steering wheel
73 steering shaft
74 drive motor
75 EPS control unit
100 subject vehicle
203 other vehicle
301e first parking space (parking available location, candidate parking location in state 300d, target parking location)
302 second parking space
303e third parking space (parking available location, candidate parking location in state 300d)
304e fourth parking space (parking, available location)
305 fifth parking space

1. A parking assist device which provides control over a subject vehicle of interest such that the subject vehicle parks into a target parking location, based on information obtained by recognizing surroundings of the subject vehicle, the parking assist device comprising:
a parking available position detection part configured to detect one or more parking available locations each of which is a location available for the subject vehicle to park, based on the recognition information; and
a target parking position determination part configured to, when the parking available position detection part detects a plurality of the parking available locations,
extract a prescribed number or a smaller number of candidate parking locations from among the detected parking available locations, based on a distance between a current location of the subject vehicle and each of the parking available locations,
display the extracted candidate parking locations in a display device, and
selects a target parking location from among the displayed candidate parking locations.

2. The parking assist device according to claim 1,
wherein, when the parking available position detection part detects a plurality of parking available locations on both a right and a left side of the subject vehicle, the target parking position determination part is configured to: extract one or more candidate parking locations from among a first prescribed number or a smaller number of parking available locations on the left side: also extract one or more candidate parking locations from among a second prescribed number or a smaller number of parking available locations on the right side; and display the respective extracted candidate parking locations in the display device.

3. The parking assist device according to claim 1,
wherein, when the current location of the subject vehicle is updated in accordance with traveling in a travel direction thereof, the parking available position detection part is configured to detect one or more updated parking available locations based on the updated recognition information, and
wherein the target parking position determination part is configured to: extract one or more updated candidate parking locations, based on a distance between the updated current location of the subject vehicle and each of the updated parking available locations; and update contents displayed in the display device, using the extracted one or more candidate parking locations.

4. The parking assist device according to claim 1,
wherein, when the parking available position detection part detects a plurality of parking available locations having respective parking orientations different from each other, the target parking position determination part is configured to make the display device display the detected parking available locations having the respective parking orientations different from each other step-by-step.

5. A parking assist method performed by a subject vehicle which provides control over a subject vehicle of interest such that the subject vehicle parks into a target parking location, based on information obtained by recognizing surroundings of the subject vehicle, the parking assist device including a parking available position detection part and a target parking position determination part, the parking assist method comprising:
a step, performed by the parking available position detection part, of detecting one or more parking available locations each of which is a location available for the subject vehicle to park, based on the recognition information;
a step, performed by the target parking position determination part, of, when the parking available position detection part detects a plurality of the parking available locations, extracting a prescribed number or a smaller number of candidate parking locations from among the detected parking available locations, based on a distance between a current location of the subject vehicle and each of the parking available locations,
a step of displaying the extracted candidate parking locations in a display device, and
a step of selecting a target parking location from among the displayed candidate parking locations.

6. A computer program product comprising at least one computer-readable storage medium having a computer-executable program stored therein for causing a computer to realize functions of the parking assist device according to claim 1.

7. A computer program product comprising at least one computer-readable storage medium having a computer-executable program stored therein for causing a computer to realize functions of the parking assist device according to claim 2.

8. A computer program product comprising at least one computer-readable storage medium having a computer-executable program stored therein for causing a computer to realize functions of the parking assist device according to claim 3.

9. A computer program product comprising at least one computer-readable storage medium having a computer-executable program stored therein for causing a computer to realize functions of the parking assist device according to claim 4.
